(19) United States
(12) Patent Application Publication
(10) Pub. No.: US 2010/0071239 A1
(43) Pub. Date: Mar. 25, 2010

(54) Illuminating sign

(76) Inventors: David Chiang, Oceanside, CA (US); John Chiang, Oceanside, CA (US)

Correspondence Address: DAVID AND RAYMOND PATENT FIRM, 108 N. YNEZ AVE., SUITE 128, MONTEREY PARK, CA, 91754, US

(21) Appl. No.: 12/284,659

(22) Filed: Sep. 23, 2008

(51) Int. Cl. G09F 13/06

(52) U.S. Cl. 40/580

(57) ABSTRACT

An illuminating sign includes a base panel; an illuminating unit, and a front casing. The front casing includes a metallic light blocking frame attached on the base panel for enhancing a strength of the front casing, wherein the light blocking frame has a plurality of through slots spacedly formed thereon, a plurality of illuminating members securely supported in front of the base panel, and a highlighting element provided at the illuminating members, wherein when the illumination unit is operated for generating the light towards the front casing, the metallic light blocking frame not only blocks the light passing therethrough but also facilitates efficient and effective heat transfer from the illuminating unit to an exterior of the front casing for preventing the illuminating unit from being overheat within the front casing.

### BACKGROUND OF THE PRESENT INVENTION

1. Field of Invention

The present invention relates to a sign, and more particularly to an illumination sign which is capable of simulating a typical neon illumination sign and avoiding the harmful effect and limitations thereof.

2. Description of Related Arts

Conventional neon illumination signs usually use argon based tubes as light source. The argon based tubes usually have mercury inside which may be harmful to the environment as well as the user when leakage occurs. Moreover, conventional neon illumination consumes more energy. As a result, LED illumination signs become more preferable and seem to be a perfect substitute for conventional neon illumination signs. Generally speaking, LED illumination produces intense illumination with less energy consumption and avoids harmful effect to the environment.

Many kinds of phosphor exist in the market today but in the present invention ultraviolet ray phosphor is preferred. The ultraviolet ray phosphor is fully activated only when impinged by ultraviolet rays. This is the working principle of color-selected LED illumination in the present invention in which unique look of phosphorus coated panels can be achieved.

Plastic forming technology employed on these signs is also important in the present invention. After the process with vacuum forming, the edges of plastics are usually rough and jagged, and subsequent coating or painting thereon becomes relatively difficult because the surface is uneven. To solve this problem, laser cutting technology is therefore applied. Laser cutting is famous for its preciseness, cleanness and silent. The plastic is processed based on the design programmed into the laser cutting machine and the edges of the plastic are much smoother than that after vacuum forming process, and the problem of subsequent coating or painting on uneven plastic surfaces is thus resolved.

As an alternative to neon signs, the illumination sign in the present invention is advantageous because it is light, invulnerable, easy to carry and consuming less power. More importantly, from the environmental point of view, there is no harmful substance in the present invention, such as argon gas or mercury, as compared to argon based neon tubes. In other words, conventional neon illumination signs contain harmful substance which causes potential danger to the users as well as the environment. Moreover, the manufacturing process of conventional neon illumination signs is complicated and expensive.

From the aesthetic point of view, some conventional illumination signs are hung on the wall and the sign characters on the illumination signs are not standing out from the background. Less attractive illumination signs may be harmful to business. The illumination signs in the present invention comprise one or more through openings which can not only make the sign characters more outstanding, but also attract more people when they can see through the illumination signs hung in the store from the through openings.

Moreover, a conventional illumination sign is usually made of plastic materials. This has the effect of being light in weight and good in heat insulation. However, a major drawback for this conventionally accepted design is that the heat generated by the large number of LEDs within the illumination sign is substantially trapped within the corresponding housing so that the LEDs or other electrical components received in that housing may burn out very easily. This is obviously undesirable. Another drawback is that a plastic made illuminating sign is usually very fragile and vulnerable to even small physical impact.

### SUMMARY OF THE PRESENT INVENTION

A main object of the present invention is to provide an illuminating sign which is capable of simulating a typical neon illumination sign and avoiding the harmful effect and limitations thereof, wherein the illuminating sign is strong in physical strength and good in heat transfer.

Another object of the present invention is to provide an illuminating sign comprising a metallic light blocking frame which is capable of facilitating sound heat transfers from a base panel to an exterior thereof, and enhancing the extent to which the illuminating sign is capable of sustaining physical impact. As such, a maximum number of illuminating units (such as LEDs) can be disposed within the base panel for a given volume thereof.

Another object of the present invention is to provide an illuminating sign which is structurally simple, inexpensive, and without utilizing anything that may be harmful to the environment, such as argon gas or mercury.

Another object of the present invention is to provide an illuminating sign, wherein the illuminating sign could be utilized in a wide variety of circumstances for providing high quality illumination of predetermined sign characters. Moreover, the present invention is capable of utilizing a wide variety of light sources for providing illumination of sign characters without substantial probability of overheating.

Accordingly, in order to accomplish the above objects, the present invention provides an illuminating sign, comprising:

a base panel;

an illuminating unit operatively mounted on the base panel for generating light; and

a front casing, which comprises:

a metallic light blocking frame attached on the base panel for enhancing a strength of the front casing, wherein the light blocking frame has a plurality of through slots spacedly formed thereon;

a plurality of illuminating members securely supported in front of the base panel, wherein each of the illuminating members has a protruding portion frontwardly protruding from the metallic light blocking frame through the respective through slot thereof to form a corresponding character sign; and

a highlighting element provided at each of the protruding portions of the illuminating members, wherein when the illumination unit is operated for generating the light towards the front casing, the metallic light blocking frame not only blocks the light passing therethrough but also facilitates efficient and effective heat transfer from the illuminating unit to an exterior of the front casing for preventing the illuminating unit from being overheat within the front casing, such that when the light from the illumination unit is converged to pass through the protruding portions of the illuminating members, the highlighting element creates a neon illuminating effect at the protruding portions thereof so as to illuminate the character signs at a front side of the light blocking frame for simulating a three dimensional neon illumination effect.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of an illuminating sign according to a preferred embodiment of the present invention.

FIG. 2 is a sectional view of the illuminating sign according to the above preferred embodiment of the present invention.

FIG. 3 is a schematic diagram of the illuminating sign according to the above preferred embodiment of the present invention.

### DETAILED DESCRIPTION OF THE PREFERRED EMBODIMENT

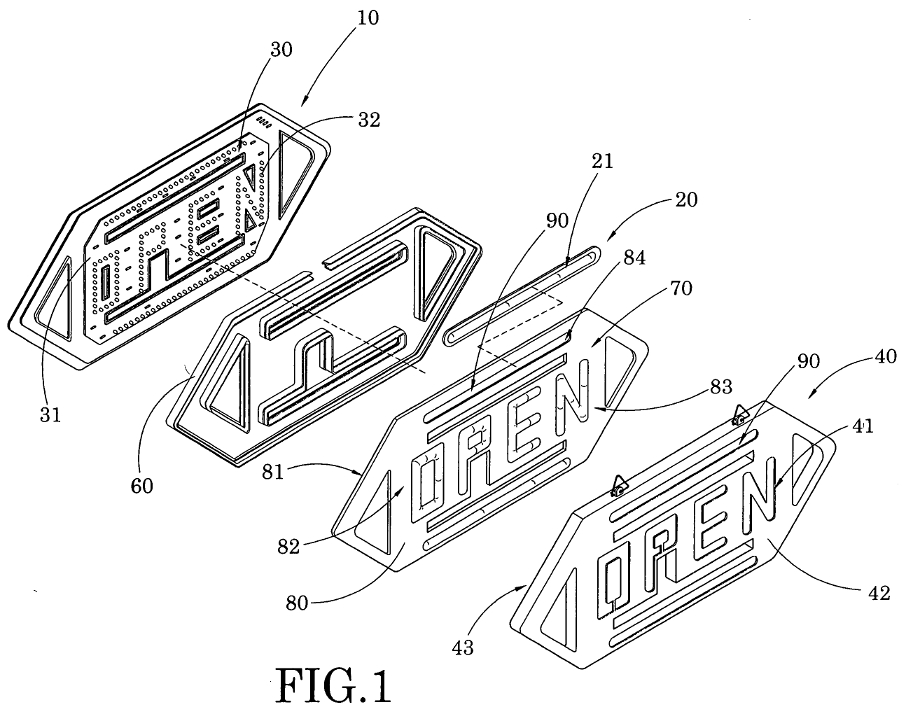

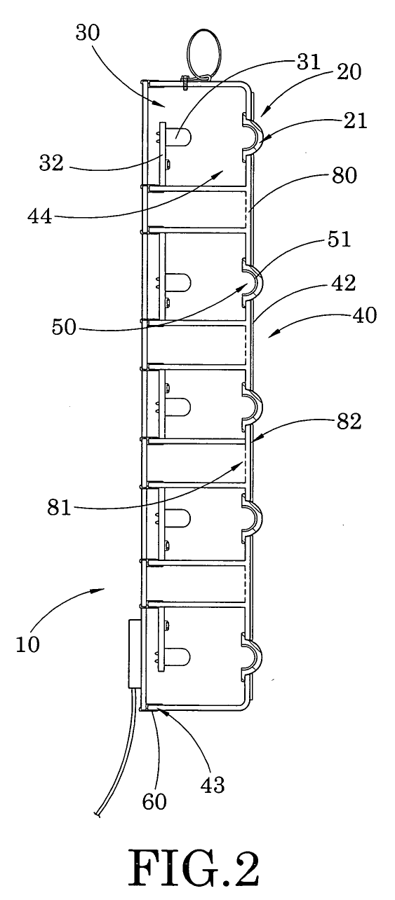

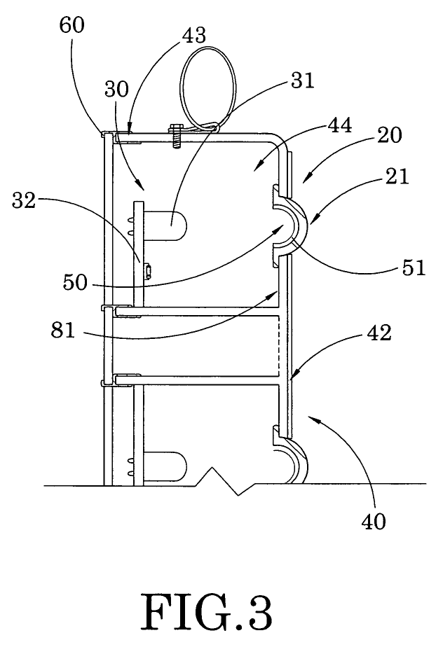

Referring to FIG. 1 to FIG. 3 of the drawings, an illuminating sign according to a preferred embodiment of the present invention is illustrated, in which the illuminating sign comprises a base panel 10, and a front casing comprising a plurality of illuminating members 20, a plurality of illuminating units 30, a metallic light blocking frame 40, and a highlighting arrangement 50.

The plurality of illuminating members 20 is securely supported at the base panel 10, wherein each of the illuminating members 20 has a protruding portion 21 to form a corresponding character sign 70 frontwardly protruded from the metallic light blocking frame 40, wherein each of the protruding portion 21 has a predetermined light transmissivity for allowing light passing there through.

The plurality of illuminating units 30 is mounted at the base panel 10 to align with the protruding portions 21 of the illuminating members 20 to provide a predetermined amount of light projecting toward the protruding portions 21 of the illuminating members 20.

The metallic light blocking frame 40 is attached on the base panel 10 for enhancing the strength of the front casing, wherein the light blocking frame 40 has a plurality of through slots 41 spacedly formed thereon to allow the protruding portions 21 of the illuminating members 20 to pass there through respectively.

The highlighting element 51 is provided at each of the protruding portions 21 of the illuminating members 20 and arranged in such a manner that when the light passes through the protruding portions 21 of the illuminating members 20, the highlighting arrangement 50 creates a neon illuminating effect at the protruding portions 21 thereof, such that the character signs 70 are illuminated at a front side of the light blocking frame 40 for simulating a three dimensional neon illumination effect, while the light blocking frame 40 is adapted for facilitating efficient and effective heat transfer from the illuminating units 30 to an exterior of the base panel 10 for preventing overheat of the illuminating sign, so that a maximum number of the illuminating units 30 are allowed to be disposed at the base panel 10 for a given area thereof without overheating. According to the preferred embodiment of the present invention, the highlighting arrangement 50 comprises a highlighting layer 51 coated at a rear side of each of the illuminating members 20. The highlighting layer 51 is preferably an ultraviolet ray phosphor which is capable of creating the neon light effect when illuminated.

According to the preferred embodiment of the present invention, the front casing further comprises a display panel 80 having an attachment side 81, an opposed displaying side 82, wherein the illuminating members 20 is spacedly formed on the display panel 80 to produce the character sign 70 at the displaying side 82 of the display panel 80. The display panel 80 thus has a background portion 83 preferably for blocking light passing through the display panel 80 from the attachment side 81 to the displaying side 82, and one or more contour openings 84 spacedly formed at the background portion 83 to align with the protruding portions 21 of the illuminating members 20 respectively for communicating the attachment side 81 with the displaying side 82, wherein the illuminating members 20 is mounted at the display panel 80 at portions aligning with the contour openings 84 so that light is capable of transmitting from base panel 10 to an exterior thereof through the contour openings 84 and the protruding portions 21 to highlight the character sign 70 at the displaying side 82 of the display panel 80.

In other words, each of the protruding portions 21 of the illuminating members 20 has a curved cross section protruding from the background portion 83 of the displaying side 82 of the display panel 80 to create the sign characters 70 in a three dimension manner. The display panel 80 may be made of light weight but durable material such as plastic, while the base panel 10 may be made of durable materials such as wood. The display panel 80 is made of light transmitting materials. In other words, the protruding portion 21 of each of the illuminating members 20 has a curved cross section frontwardly protruding out of a front side of the metallic light blocking frame 40 through the respective through slot 41.

The metallic light blocking frame 40 has a receiving cavity 44 and comprises a metallic front panel 42 attached on the background portion 83 of the display panel 80 wherein the though slots 41 are formed on the metallic front panel 42 and are aligned with the protruding portions 21 of the illuminating members 20 respectively such that the protruding portions 21 are arranged to protrude from the displaying side 82 of the display panel 80 and the metallic front panel 42. It is important to point out that since the metallic front panel 42, as its name implies, is made of metal, it has a relatively high heat transfer capability so that heat generated from the base panel 10 can be effectively transferred out of the base panel 10 for effectively preventing overheating of the illuminating sign.

The metallic light blocking frame 40 further comprises an engagement rim 43 peripherally formed along the metallic front panel 42 to securely engage with a peripheral edge of the base panel 10, so that the heat generated within the receiving cavity 44 is adapted to be effectively and efficiently transferred out of the front casing through the metallic light blocking frame 40.

Thus, the display panel 80 is integrally linked with said illuminating members 20 to form a one piece planar structure overlapping at a rear side of the metallic front panel 42, such that said protruding portions 21 of said illuminating members 20 are integrally protruded from a front displaying side 82 of the display panel 80 to form the character signs 70.

Moreover, the illuminating unit 30 comprises a circuit panel 31 overlapped on the base panel and a plurality of LEDs 32 electrically coupled on the circuit panel 31 and arranged in a predetermined array to align with the protruding portions 21 of the illuminating members 20 so as to alignedly project the light towards the protruding portions 21 of the illuminating members 20.

There are several advantages for the light blocking frame 40 being made of metallic materials, such as aluminum. First, the metallic front panel 42 is durable due to its material strength, is adapted for use in indoor/outdoor environment, and can be accurately cut by a computerized plasma cutter which is adapted to cut sheet metal (usually 0.6 mm to 1.0 mm in thickness) according to specified design pattern. Thus, the manufacturer of the present invention can make sure that the through slots 41 are spacedly formed at the precise positions on the metallic front panel 42 to align with the protruding portions 21 of the illuminating members 20 respectively.

Second, the metallic light blocking frame 40 can be attached onto the base panel 10 by welding. This is an extremely convenient and economical method of manufacturing the present invention. Moreover, the entire manufacturing process can also be further simplified by manufacturing the display panel 80 through thermal forming via routed mold.

Third, the front casing further comprises a silicone rubber 60 applied along a gap between the engagement rim 43 and the base panel 10 to fill the gap for preventing the light from leaking out of the receiving cavity 44 through the gap. Thus, the special design silicone rubber 60 is applied onto the intersection of the light blocking frame 40 (i.e. in the vicinity of the engagement rim 43) and the base panel 10 so as to provide an unique decorative effect and to prevent light from leaking out of the base panel through any gap formed between the light blocking frame 40 and the base panel 10.

Fourth, conventional cutting method (such as hydraulic press technology) can be utilized to conveniently and easily cut the outer shape of the display panel 80 and the metallic front panel 42 with the through slots 41 formed thereon for fittedly engaging with the base panel 10. The shape of the display panel 80 and the metallic front panel 42 and the sign character 70 can be conveniently visualized and formed with the aid of a specially-programmed computer. The display panel 80 is then bond with the metallic front panel 42 through predetermined adhesive agent or other conventional connectors so as to allow the three-dimensional neon light effect to be optimally produced. The manufacturing method can also allow effective and efficient mass production of the metallic light blocking frame 40.

In order to further enhance the aesthetic appearance of the present invention, the illuminating sign further has at least one aesthetic slot 90 formed on the base panel 10 so that the display panel 80 and the light blocking frame 40 are shaped and sized not to cover the aesthetic slot 90.

In light of the above descriptions, one skilled in the art would have appreciated two further advantages of the present invention. First, the phosphor coating on the lens increases light output by more than 30%. In other words, the same brightness can be achieved with a lower intensity light which saves an additional 30% of energy consumption. Second, utilizing metal as the metallic light blocking frame 40 can save tooling time and that the metallic light blocking frame 40 is also recyclable, which makes this particular portion of the present invention and the corresponding manufacturing method environmentally friendly.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An illuminating sign, comprising:
a base panel;
an illuminating unit operatively mounted on said base panel for generating light; and
a front casing, which comprises:
a metallic light blocking frame attached on said base panel for enhancing a strength of said front casing, wherein said light blocking frame has a plurality of through slots spacedly formed thereon;
a plurality of illuminating members securely supported in front of said base panel, wherein each of said illuminating members has a protruding portion frontwardly protruding from said metallic light blocking frame through said respective through slot thereof to form a corresponding character sign; and
a highlighting element provided at each of said protruding portions of said illuminating members, wherein when said illumination unit is operated for generating said light towards said front casing, said metallic light blocking frame not only blocks said light passing therethrough but also facilitates efficient and effective heat transfer from said illuminating unit to an exterior of said front casing for preventing said illuminating unit from being overheat within said front casing, such that when said light from said illumination unit is converged to pass through said protruding portions of said illuminating members, said highlighting element creates a neon illuminating effect at said protruding portions thereof so as to illuminate said character signs at a front side of said light blocking frame for simulating a three dimensional neon illumination effect.

2. The illuminating sign, as recited in claim 1, wherein said highlighting element comprises a highlighting layer coated at a rear side of each of said illuminating members.

3. The illuminating sign, as recited in claim 1, wherein said protruding portion of each of said illuminating members has a curved cross section frontwardly protruding out of a front side of said metallic light blocking frame through said respective through slot.

4. The illuminating sign, as recited in claim 2, wherein said protruding portion of each of said illuminating members has a curved cross section frontwardly protruding out of a front side of said metallic light blocking frame through said respective through slot.

5. The illuminating sign, as recited in claim 1, wherein said metallic light blocking frame has a receiving cavity and comprises a metallic front panel forming said through slots thereat and an metallic engagement rim peripherally formed along said metallic front panel to securely engage with a peripheral edge of said base panel, so that said heat generated within said receiving cavity is adapted to be effectively and efficiently transferred out of said front casing through said metallic light blocking frame.

6. The illuminating sign, as recited in claim 2, wherein said metallic light blocking frame has a receiving cavity and comprises a metallic front panel forming said through slots thereat and an metallic engagement rim peripherally formed along said metallic front panel to securely engage with a peripheral edge of said base panel, so that said heat generated within said receiving cavity is adapted to be effectively and efficiently transferred out of said front casing through said metallic light blocking frame.

7. The illuminating sign, as recited in claim 4, wherein said metallic light blocking frame has a receiving cavity and comprises a metallic front panel forming said through slots thereat and an metallic engagement rim peripherally formed along said metallic front panel to securely engage with a peripheral edge of said base panel, so that said heat generated within said receiving cavity is adapted to be effectively and efficiently transferred out of said front casing through said metallic light blocking frame.

8. The illuminating sign, as recited in claim 5, wherein said front casing further comprises a silicone rubber applied along a gap between said the engagement rim and said base panel to fill said gap for preventing said light from leaking out of said receiving cavity through said gap.

9. The illuminating sign, as recited in claim 6, wherein said front casing further comprises a silicone rubber applied along a gap between said the engagement rim and said base panel to fill said gap for preventing said light from leaking out of said receiving cavity through said gap.

10. The illuminating sign, as recited in claim 7, wherein said front casing further comprises a silicone rubber applied along a gap between said the engagement rim and said base panel to fill said gap for preventing said light from leaking out of said receiving cavity through said gap.

11. The illuminating sign, as recited in claim 5, wherein said front casing further comprises a display panel integrally linked with said illuminating members to form a one piece planar structure overlapping at a rear side of said metallic front panel, such that said protruding portions of said illuminating members are integrally protruded from a front side of said display panel to form said character signs.

12. The illuminating sign, as recited in claim 7, wherein said front casing further comprises a display panel integrally linked with said illuminating members to form a one piece planar structure overlapping at a rear side of said metallic front panel, such that said protruding portions of said illuminating members are integrally protruded from a front side of said display panel to form said character signs.

13. The illuminating sign, as recited in claim 10, wherein said front casing further comprises a display panel integrally linked with said illuminating members to form a one piece planar structure overlapping at a rear side of said metallic front panel, such that said protruding portions of said illuminating members are integrally protruded from a front side of said display panel to form said character signs

14. The illuminating sign, as recited in claim 11, wherein said display panel, having a uniform thickness, has a plurality of channels indently formed at a rear side of said display panel to correspondingly form said protruding portions at said illuminating members.

15. The illuminating sign, as recited in claim 12, wherein said display panel, having a uniform thickness, has a plurality of channels indently formed at a rear side of said display panel to correspondingly form said protruding portions at said illuminating members.

16. The illuminating sign, as recited in claim 13, wherein said display panel, having a uniform thickness, has a plurality of channels indently formed at a rear side of said display panel to correspondingly form said protruding portions at said illuminating members.

17. The illuminating sign, as recited in claim 1, wherein said illuminating unit comprises a circuit panel overlapped on said base panel and a plurality of LEDs electrically coupled on said circuit panel and arranged in a predetermined array to align with said protruding portions of said illuminating members so as to alignedly project said light towards said protruding portions of said illuminating members.

18. The illuminating sign, as recited in claim 7, wherein said illuminating unit comprises a circuit panel overlapped on said base panel and a plurality of LEDs electrically coupled on said circuit panel and arranged in a predetermined array to align with said protruding portions of said illuminating members so as to alignedly project said light towards said protruding portions of said illuminating members.

19. The illuminating sign, as recited in claim 16, wherein said illuminating unit comprises a circuit panel overlapped on said base panel and a plurality of LEDs electrically coupled on said circuit panel and arranged in a predetermined array to align with said protruding portions of said illuminating members so as to alignedly project said light towards said protruding portions of said illuminating members.

20. The illuminating sign, as recited in claim 2, wherein said highlighting element is ultraviolet ray phosphor coating coated on said rear side of each of said illuminating units.

21. The illuminating sign, as recited in claim 19, wherein said highlighting element is ultraviolet ray phosphor coating coated on said rear side of each of said illuminating units.

22. The illuminating sign, as recited in claim 1, wherein said metallic light blocking frame is made of Aluminum.

23. The illuminating sign, as recited in claim 21, wherein said metallic light blocking frame is made of Aluminum.
